(19) United States
(12) Patent Application Publication
(10) Pub. No.: US 2025/0306523 A1
(43) Pub. Date: Oct. 2, 2025

(54) IMAGE FORMING APPARATUS

(71) Applicant: KYOCERA Document Solutions Inc., Osaka (JP)

(72) Inventor: Satoshi ISHII, Osaka (JP)

(73) Assignee: KYOCERA Document Solutions Inc., Osaka (JP)

(21) Appl. No.: 19/078,210

(22) Filed: Mar. 12, 2025

(30) Foreign Application Priority Data
Mar. 26, 2024 (JP) 2024-048995

(51) Int. Cl. G03G 21/16; G03G 15/00

(52) U.S. Cl. CPC G03G 21/1647; G03G 15/6573; G03G 21/1638; G03G 2215/00421; G03G 2215/00544; G03G 2221/1675

(57) ABSTRACT

An image forming apparatus includes a relay conveying unit, a driving unit, and a cover. The relay conveying unit includes a conveying member, and is housed in a storage space of an apparatus main body so as to be pulled out. The driving unit is provided in the apparatus main body, and is coupled to the relay conveying unit housed in the storage space. The cover is turnable, and opens and closes the storage space. The relay conveying unit includes a hook which is engaged with the apparatus main body when the relay conveying unit is coupled to the driving unit. The cover includes an operation part which pushes the relay conveying unit toward the storage space to connect the relay conveying unit to the driving unit and to engage the hook with the apparatus main body by turning in a direction of closing the storage space.

### INCORPORATION BY REFERENCE

This application is based on and claims the benefit of priority from Japanese patent application No. 2024-048995 filed on Mar. 26, 2024, which is incorporated by reference in its entirety.

### BACKGROUND

The present disclosure relates to an image forming apparatus provided with a relay conveying unit.

The image forming apparatus may be configured such that an apparatus main body includes an in-body sheet discharge space, and a sheet on which an image is formed in an image forming part is discharged on a tray formed on the bottom surface of the in-body sheet discharge space. When a post-processing device for post-processing on the sheet is connected to the image forming apparatus provided with such an in-body sheet discharge space, a relay conveying unit is installed in the in-body sheet discharge space. The relay conveying unit is formed with a relay conveyance path along which the image-formed sheet is conveyed to the post-processing device.

In the image forming apparatus provided with such a relay conveying unit, the relay conveying unit includes a conveying member for conveying the sheet, and the apparatus main body includes a driving mechanism for applying a driving force to the conveying member. When the relay conveying unit is connected to the driving mechanism, a driving force is applied to the conveying member.

In such an image forming apparatus, the relay conveying unit is provided so as to be pulled out from the in-body sheet discharge space in order to treat a sheet jam or the like. In this case, when the relay conveying unit is pushed into the in-body sheet discharge space after the sheet jam treatment, if the relay conveying unit is not positioned at a normal position (half-pushed state), the relay conveying unit and the driving mechanism are not properly connected. This causes a problem that a sheet jam occurs due to defective drive of the conveying member.

### SUMMARY

An image forming apparatus according to the present disclosure includes a relay conveying unit, a driving unit, and a cover. The relay conveying unit includes a conveying member for conveying a sheet on which an image is formed, and is housed in a storage space of an apparatus main body so as to be pulled out. The driving unit is provided in the apparatus main body, and is coupled to the relay conveying unit housed in the storage space to apply a driving force to the relay conveying unit. The cover is turnable, and opens and closes the storage space. The relay conveying unit includes a hook which is engaged with the apparatus main body when the relay conveying unit is coupled to the driving unit. The cover includes an operation part which pushes the relay conveying unit toward the storage space to connect the relay conveying unit to the driving unit and to engage the hook with the apparatus main body by turning in a direction of closing the storage space.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an internal structure of an image forming apparatus according to one embodiment of the present disclosure.

FIG. 2 is a perspective view showing a front cover of the image forming apparatus according to the embodiment of the present disclosure.

FIG. 3 is a cross-sectional view showing the front cover of the image forming apparatus according to the embodiment of the present disclosure.

FIG. 4A is a plan view schematically showing a relay conveying unit and a driving unit (a state in which the relay conveying unit is pulled out from an in-body sheet discharge space) of the image forming apparatus according to the embodiment of the present disclosure.

FIG. 4B is a plan view schematically showing the relay conveying unit and the driving unit (a state in which the relay conveying unit is housed in the in-body sheet discharge space) of the image forming apparatus according to the embodiment of the present disclosure.

FIG. 5 is a cross-sectional view showing a conveying unit engaging part in the image forming apparatus according to the embodiment of the present disclosure.

FIG. 6 is a perspective view showing the relay conveying unit of the image forming apparatus according to the embodiment of the present disclosure.

FIG. 7 is a part of a cross-sectional view taken along the line II-II of FIG. 6.

FIG. 8 is a part of a cross-sectional view takin along the line VIII-VIII of FIG. 6.

FIG. 9 is a perspective view showing a handle member of the relay conveying unit in the image forming apparatus according to the embodiment of the present disclosure.

FIG. 10 is a side view explaining a state in which the relay conveying unit is housed in the in-body sheet discharge by the front cover, in the image forming apparatus according to the embodiment of the present disclosure.

FIG. 11 is a side view explaining the state in which the relay conveying unit is housed in the in-body sheet discharge space by the front cover, in the image forming apparatus according to the embodiment of the present disclosure.

FIG. 12 is a side view explaining the state in which the relay conveying unit is housed in the in-body sheet discharge space by the front cover, in the image forming apparatus according to the embodiment of the present disclosure.

FIG. 13 is a perspective view showing a pushing member supported by the relay conveying unit in the image forming apparatus according to another embodiment of the present disclosure.

FIG. 14 is a side view explaining a state in which the relay conveying unit is housed in the in-body sheet discharge space by the front cover in the image forming apparatus according to another embodiment of the present disclosure.

FIG. 15 is a side view explaining the state in which the relay conveying unit is housed in the in-body sheet discharge space by the front cover in the image forming apparatus according to another embodiment of the present disclosure.

### DETAILED DESCRIPTION

Hereinafter, with reference to the drawings, an image forming apparatus according to an embodiment of the present disclosure will be described.

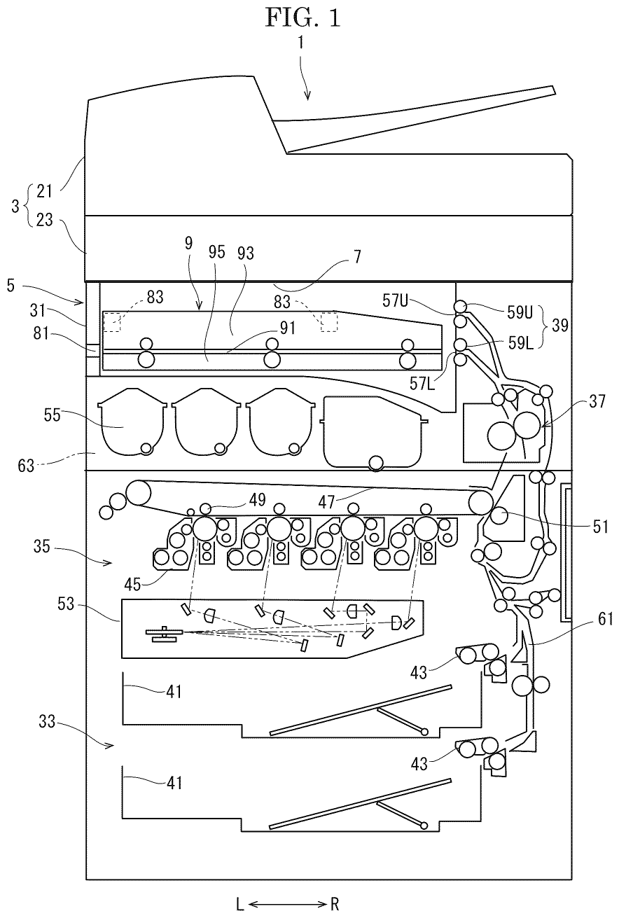

First, with reference to FIG. 1, the entire structure of the image forming apparatus 1 will be described. FIG. 1 is a front view schematically showing an internal structure of the image forming apparatus 1. Fr, Rr, L, and R shown in each figure indicate the front side, rear side, left side, and right side of the image forming apparatus 1, respectively.

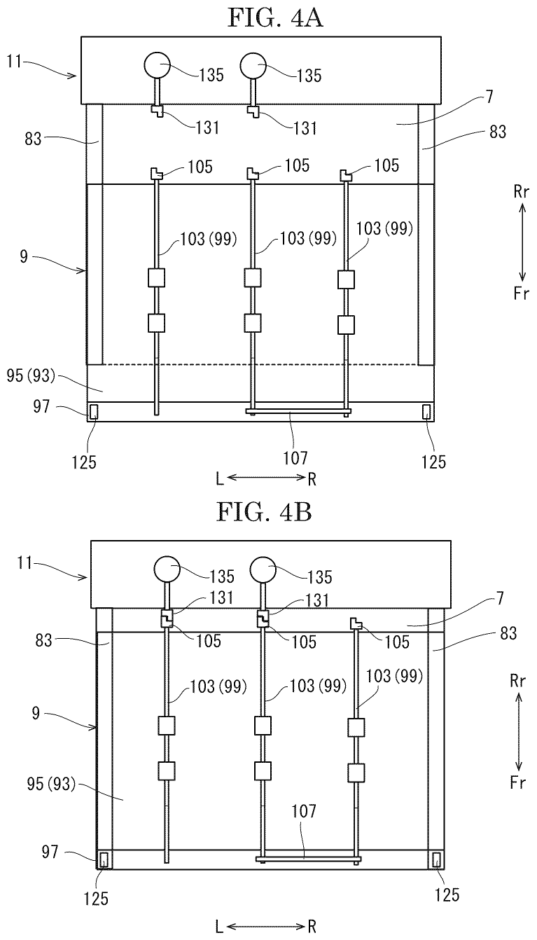

The image forming apparatus 1 includes an image reading part 3 and an image forming part 5 provided below the image reading part 3. Between the image reading part 3 and the image forming part 5, an in-body sheet discharge space 7 having an open front surface is formed. In the in-body sheet discharge space 7, a relay conveying unit 9 and a driving unit 11 (not shown in FIG. 1, see FIG. 4A and FIG. 4C) are housed. A post-processing apparatus (not shown) is disposed adjacent to the image forming apparatus 1.

First, the image reading part 3 will be described. The image reading part 3 includes a conveying unit 21 which conveys a document and a reading unit 23 which reads an image of the conveyed document.

Next, the image forming part 5 will be described. The image forming part 5 includes an apparatus main body 31 having a box-shaped housing structure. The apparatus main body 31 includes a sheet feeding part 33 which feeds a sheet, a toner image forming part 35 which forms a toner image transferred to the sheet, a fixing part 37 which fixes the toner image to the sheet, and a discharging part 39 which discharges the sheet on which the toner image is fixed.

The sheet feeding part 33 is disposed in the lower portion in the apparatus main body 31. The sheet feeding part 33 includes a sheet feeding cassette 41 in which the sheets are stored, and a sheet feeding device 43 which feeds the sheet stored in the sheet feeding cassette 41.

The toner image forming part 35 is disposed above the sheet feeding part 33. The toner image forming part 35 includes four toner image forming units 45 corresponding to the toner of four colors (yellow, cyan, magenta, and black), an intermediate transfer belt 47, primary transfer rollers 49 corresponding to the four toner image forming units 45, a secondary transfer roller 51, and an exposure device 53. The four toner image forming units 45 are arranged side by side in the left-and-right direction.

The intermediate transfer belt 47 is disposed above the four toner image forming units 45, and wound between a driving roller and a driven roller which are disposed apart in the left-and-right direction. The intermediate transfer belt 47 travels in the counterclockwise direction of FIG. 1 when the driving roller rotates. The outer surface of the lower track of the intermediate transfer belt 47 faces the four toner image forming units 45, and forms primary transfer nips between the toner image forming units 45 and the intermediate transfer belt 47. The four primary transfer rollers 49 are disposed in the hollow space of the intermediate transfer belt 47, and face the four toner image forming units 45 across the intermediate transfer belt 47. The secondary transfer roller 51 faces the driving roller across the intermediate transfer belt 47, and forms a secondary transfer nip between the secondary transfer roller 51 and the intermediate transfer belt 47.

Above the intermediate transfer belt 47, four toner containers 55 each containing the toner of four colors are stored side by side in the left-and-right direction. The toner containers 55 can be pulled out along the front-and-rear direction. Each toner container 55 is connected to the corresponding toner image forming unit 45.

The fixing part 37 is disposed above the secondary transfer nip. The fixing part 37 includes a heating roller and a pressing roller, and a fixing nip is formed between both rollers.

The discharging part 39 is disposed above the fixing part 37 on the right side of the in-body sheet discharge space 7. The discharging part 39 includes an upper pair of discharging rollers 59U and a lower pair of discharging rollers 59L. The upper pair of discharging rollers 59U and the lower pair of discharging rollers 59L are disposed inside an upper discharge port 57U and a lower discharge port 57L formed on the right side wall of the in-body sheet discharge space 7, respectively.

Further, in the apparatus main body 31, a sheet conveyance path 61 is formed from the sheet feeding device 43 of the sheet feeding part 33 to the upper and lower discharge ports 57U and 57L through the secondary transfer nip and the fixing nip.

Further, a front cover 63 for covering the front of the in-body sheet discharge space 7 and the four toner containers 55 is rotatably supported by the apparatus main body 31. When the front cover 63 is opened, it becomes possible to detach the empty toner container 55 and attach a new toner container 55. Further, when the front cover 63 is opened, the in-body sheet discharge space 7 is opened, and as described later, the relay conveying unit 9 housed in the in-body sheet discharge space 7 can be pulled out. As described above, the in-body sheet discharge space 7 is an example of the storage space in which the relay conveying unit 9 is stored, and the front cover 63 is an example of the turnable cover for opening and closing the storage space in the present disclosure. The front cover 63 will be described later.

An image forming operation by the image forming part 5 will be briefly described. The toner image formed in each toner image forming unit 45 is transferred to the intermediate transfer belt 47 by the primary transfer roller 49 to which a transfer bias is applied in the primary transfer nip. In the four toner image forming units 45, the toner images are respectively transferred to the intermediate transfer belt 47 to form a full-color toner image on the intermediate transfer belt 47.

In the sheet feeding part 33, the sheet is fed from the sheet feeding cassette 41 to the conveyance path 61 by the sheet feeding device 43. The sheet is conveyed to the secondary transfer nip along the conveyance path 61. In the secondary transfer nip, the full-color toner image is transferred from the intermediate transfer belt 47 to the sheet by the secondary transfer roller 51 to which a transfer bias is applied. Thereafter, the sheet is conveyed to the fixing part 37, and the toner image is heated and pressurized in the fixing nip to be fixed to the sheet. The sheet is conveyed to the discharging part 39, and discharged from either of the upper and lower discharge ports 57U and 57L by the upper and lower pairs of discharging rollers 59U and 59L.

When the sheet is not subjected to post-processing by the post-processing apparatus, the sheet is discharged from the upper discharge port 57U, and loaded on the upper surface of the relay conveying unit 9. When the sheet is subjected to post-processing by the post-processing apparatus, the sheet is discharged from the lower discharge port 57L and conveyed to the post-processing apparatus by the relay conveying unit 9.

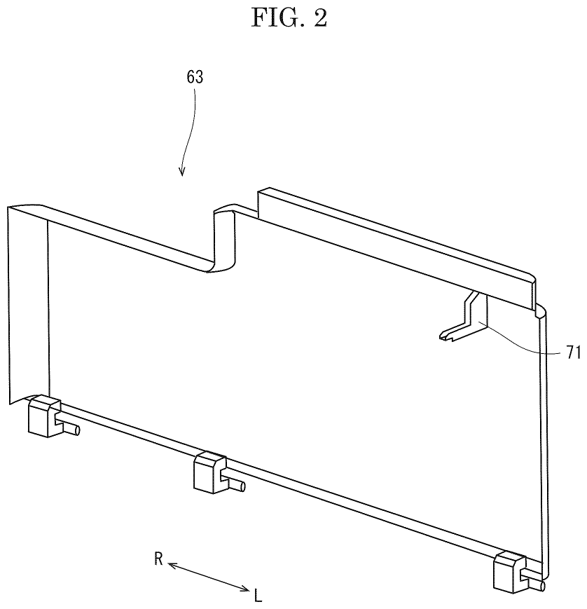

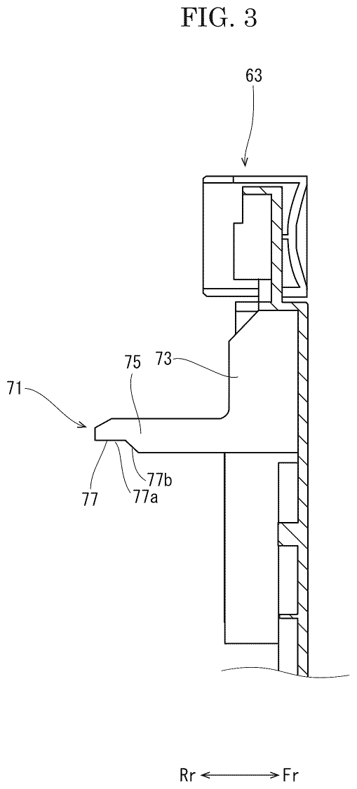

Next, the front cover 63 will be described with reference to FIG. 2 and FIG. 3. FIG. 2 is a perspective view of the front cover 63 viewed from the rear side, and FIG. 3 is a cross-sectional view showing the front cover 63. The front cover 63 is a plate-shaped member having a dimension capable of covering the in-body sheet discharge space 7 and the front of the four toner containers 55. The front cover 63 is turnable upward and downward around a rotational shaft provided below the housed toner container 55.

As shown in FIG. 2, the front cover 63 has a rib along the upper and side edges of the inner surface. Further, on the inner surface of the front cover 63, a plurality of reinforcing ribs (not shown) are formed along the front-and-lower direction, the left-and-right direction, and oblique directions. Further, a projection 71 projecting at a right angle with respect to the inner surface of the front cover 63 is formed at the upper left corner (the upper right corner when viewed from the rear side) of the inner surface.

The projection 71 is formed by a pair of side plates each having an L-shape when viewed from the left-and-right direction and a bottom plate between the pair of side plates. As shown in FIG. 3, the projection 71 has a base portion 73 and a projecting portion 75. The base portion 73 is provided in parallel with the inner and outer surfaces of the front cover 63. The projecting portion 75 projects more rearward from the lower end of the base portion 73 than the ribs of the front cover 63. The upper corner of the projecting portion 75 is tapered. A notch 77 is formed at the lower corner of the projecting portion 75. The notch 77 has an upper surface 77a along a direction perpendicular to the base portion 73 and a rear surface 77b inclined upward toward the upper surface 77a.

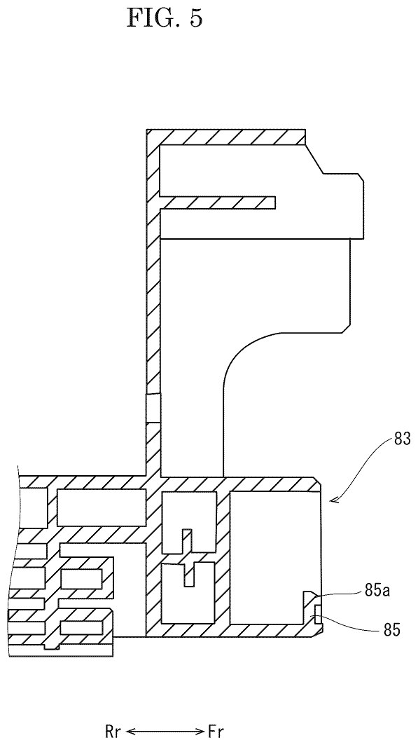

Next, the relay conveying unit 9 and the driving unit 11 will be described. First, the in-body sheet discharge space 7 in which the units 9 and 11 are housed will be described with reference to FIG. 1, FIG. 4A, FIG. 4B, and FIG. 5. FIGS. 4A and FIG. 4B are plan views schematically showing the in-body sheet discharge space 7, the relay conveying unit 9, and the driving unit 11, and FIG. 5 is a side view showing a conveying unit engaging part 83 provided in the in-body sheet discharge space 7. FIG. 1 schematically shows the position of the conveying unit engaging parts 83.

As described above, the in-body sheet discharge space 7 is a space whose front surface is opened. As shown in FIG. 1, the upper and lower discharge ports 57U and 57L are formed on the right side wall of the in-body sheet discharge space 7, as described above. A discharge port 81 through which the sheet is discharged to the post-processing device is formed on the left side wall of the in-body sheet discharge space 7. The discharge port 81 is disposed at substantially the same height as the lower discharge port 57L.

As shown in FIG. 4A and FIG. 4B, the right and left conveying unit engaging parts 83 are provided in the in-body sheet discharge space 7. As shown in FIG. 5, the conveying unit engaging part 83 is a rectangular cylindrical portion integrally provided with the apparatus main body 31 and extending in the front-and-rear direction. For example, the conveying unit engaging parts 83 are formed integrally with the upper wall and the right and left side walls of the in-body sheet discharge space 7. The front surface of the conveying unit engaging part 83 is opened. In the opening, an engaging piece 85 is formed along the lower edge. A hook projecting forward is formed at the upper end of the engaging piece 85. The upper surface 85a of the engaging piece 85 is inclined upward from the front to the rear.

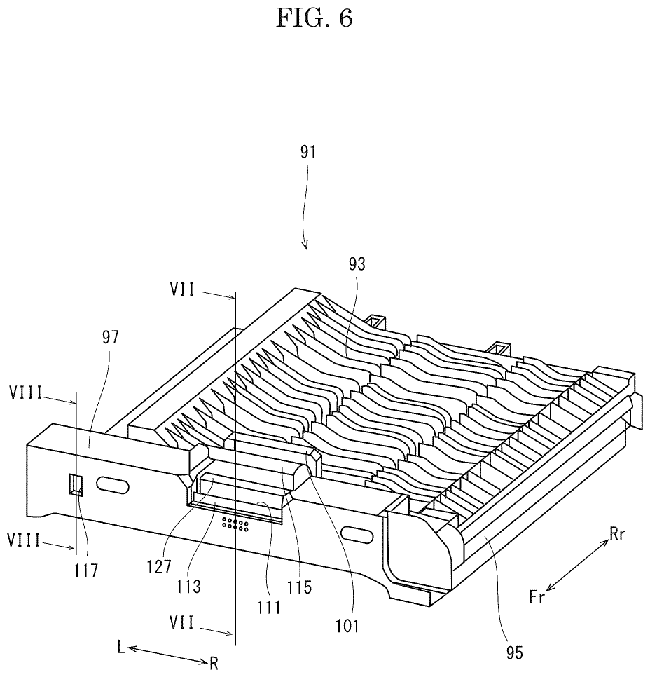

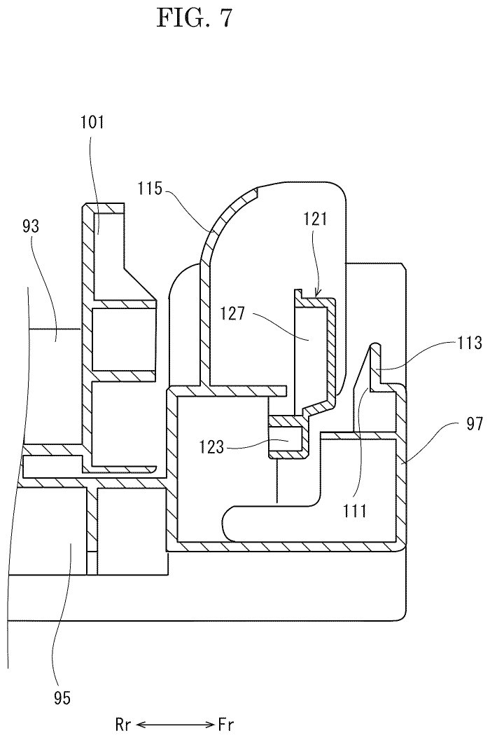

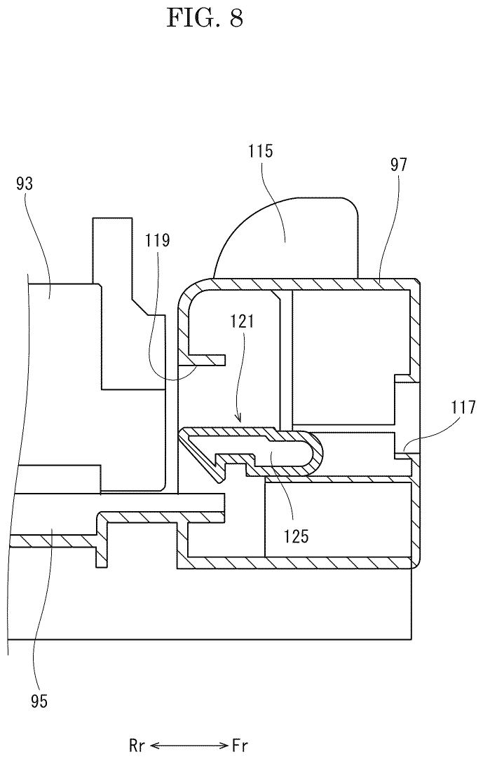

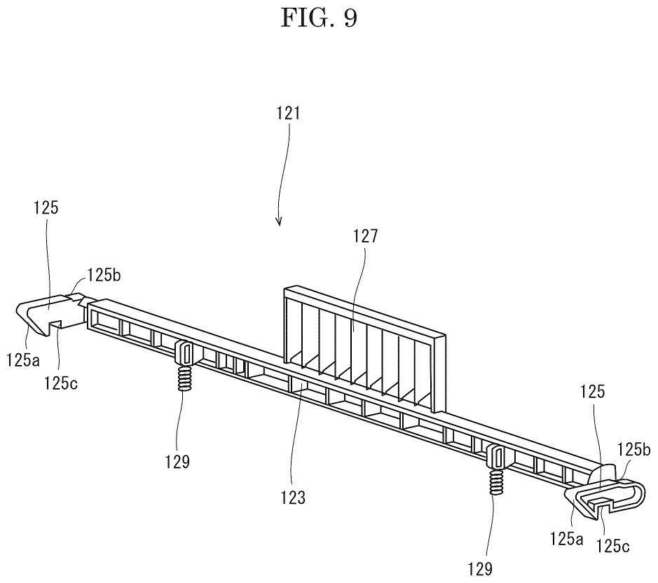

Next, the relay conveying unit 9 will be described with reference to FIG. 4A and FIG. 4B, and FIG. 6, FIG. 7, FIG. 8, and FIG. 9. FIG. 6 is a perspective view showing the relay conveying unit 9, FIG. 7 and FIG. 8 are sectional views showing the relay conveying unit 9, and FIG. 9 is a perspective view showing a handle member.

As shown in FIG. 6, the relay conveying unit 9 includes upper and lower conveyance guides 93 and 95 forming a relay conveyance path 91 (see FIG. 1) along the conveyance direction from the lower discharge port 57L to the discharge port 81, and a front panel 97.

The upper surface of the upper conveyance guide 93 forms a placement surface on which the sheet discharged through the upper discharge port 57U is loaded. A plurality of ribs along the conveyance direction are formed on the placement surface. The lower surface of the upper conveyance guide 93 forms an upper guide surface of the relay conveyance path 91. A plurality of ribs along the conveyance direction are formed on the upper guide surface. Further, as shown in FIG. 4A and FIG. 4B, three driven rollers 99 are rotatably supported on the upper guide surface at predetermined intervals in the conveyance direction.

A handle 101 projecting upward is formed at the center of the front end portion of the upper conveyance guide 93 in the left-and-right direction.

The upper surface of the lower conveyance guide 95 forms a lower guide surface of the relay conveyance path 91. A plurality of ribs along the conveyance direction are formed on the lower guide surface. Further, as shown in FIG. 4A and FIG. 4B, three conveying rollers 103 are rotatably supported on the lower guide surface at predetermined intervals in the conveyance direction. A coupling 105 is fixed to the rear end of the rotational shaft of each conveying roller 103. The rotational shafts of the two upstream conveying rollers 103 are connected by a timing belt 107.

The rear end of the upper conveyance guide 93 is turnably supported by the rear end of the lower conveyance guide 95. When the upper conveyance guide 93 is turned downward, the relay conveyance path 91 is formed between the upper and lower guide surfaces of the upper and lower conveyance guides 93 and 95. Further, the three driven rollers 99 are brought into contact with the three conveying rollers 103. On the other hand, by holding the handle 101 and then turning the upper conveyance guide 93 upward, the relay conveyance path 91 is opened, and the sheet jam generated in the relay conveyance path 91 can be treated.

The front panel 97 is a hollow part provided along the front end of the lower conveyance guide 95. As shown in FIG. 6 and FIG. 7, a rectangular upper opening 111 is formed at the center of the upper wall of the front panel 97 in the left-and-right direction. Further, the upper wall of the front panel 97 has a rectangular front fixing piece 113 provided in front of the opening 111. Further, the upper wall of the front panel 97 has a rear fixing piece 115 provided in the rear side of the opening 111. The rear fixing piece 115 has a rectangular shape having a higher height than the front fixing piece 113, and its upper portion is curved forward in an arc shape.

As shown in FIG. 6 and FIG. 8, the front wall of the front panel 97 has an elongated rectangular front opening 117 formed at the left end portion. Further, as shown in FIG. 8, the rear wall of the front panel 97 has left and right rectangular rear openings 119 formed at the left and right end portions.

A handle member 121 is supported in a hollow space of the front panel 97. The handle member 121 will be described with reference to FIG. 9. The handle member 121 has a rotational shaft 123 having a rectangular cross-sectional shape, left and right hooks 125 provided at both ends of the rotational shaft 123, and a handle 127 provided at the center of the rotational shaft 123.

The left and right hooks 125 extend from both ends of the rotational shaft 123 in a direction orthogonal to the axial direction of the rotational shaft 123. The tip end surface 125a of the hook 125 is inclined diagonally downward from the upper surface to the lower surface. The upper surface of the hook 125 has a rotational shaft side surface and the distal end side surface. The rotational shaft side surface is lower than the distal end side surface, and a stepped surface 125b facing the rotational shaft side is formed between both surfaces. On the lower surface of the hook 125, a recess 125c is formed along the lower edge of the tip end surface 125a.

The handle 127 is orthogonal to a direction in which the hook 125 extends and orthogonal to the axial direction of the rotational shaft 123.

The handle member 121 is housed in the hollow space of the front panel 97, and both end portions of the rotational shaft 123 are rotatably supported by the front panel 97. As shown in FIG. 6 and FIG. 7, the handle 127 projects upwardly through the upper opening 111 formed in the upper wall of the front panel 97. As shown in FIG. 8, the left and right hooks 125 face the left and right rear openings 119 of the rear wall of the front panel 97. As shown in FIG. 9, the handle member 121 is maintained in an initial position in which the handle 127 extends along the vertical direction and the left and right hooks 125 extend rearward along the horizontal direction, by two springs 129. When the handle 127 is moved forward in the upper opening 111, the rotational shaft 123 is rotated, and the left and right hooks 125 are rotated upward.

Next, the driving unit 11 will be described with reference to FIG. 4A and FIG. 4B. The driving unit 11 is disposed on the inner side (rear side) of the in-body sheet discharge space 7. The driving unit 11 includes two couplings 131 connectable to the couplings 105 of the two conveying rollers 103 of the relay conveying unit 9, and two motors 135 as the two drive sources connected to the two couplings 131. When the relay conveying unit 9 is housed in the normal position in the in-body sheet discharge space 7, the couplings 105 of the two conveying rollers 103 are coupled to the couplings 131 of the driving unit 11 (see FIG. 4B). After the couplings 105 and 131 are connected, the motors 135 are driven, so that the driving force of the motors 135 is transmitted to the conveying rollers 103 via the couplings 105 and 131, and the conveying roller 103 rotates. As a result, the sheet is conveyed along the relay conveyance path 91.

On the other hand, when the relay conveying unit 9 is pulled out forward through the front opening of the in-body sheet discharge space 7, the couplings between the couplings 105 and 131 are released (see FIG. 4A).

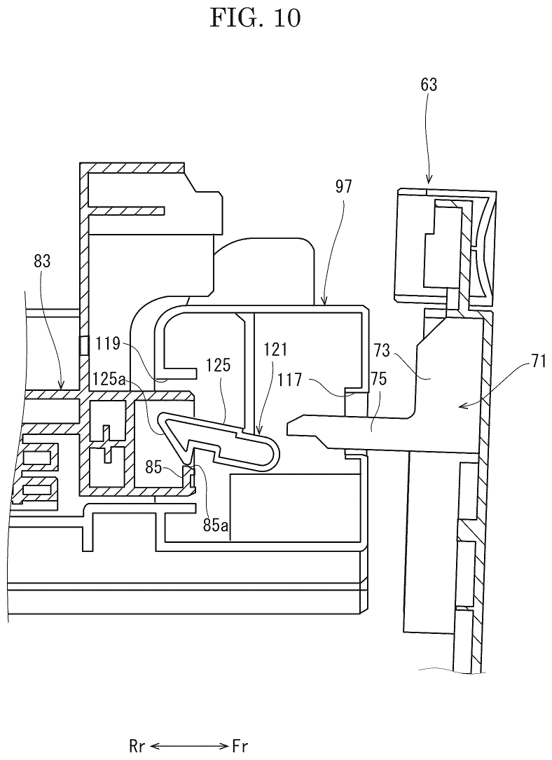

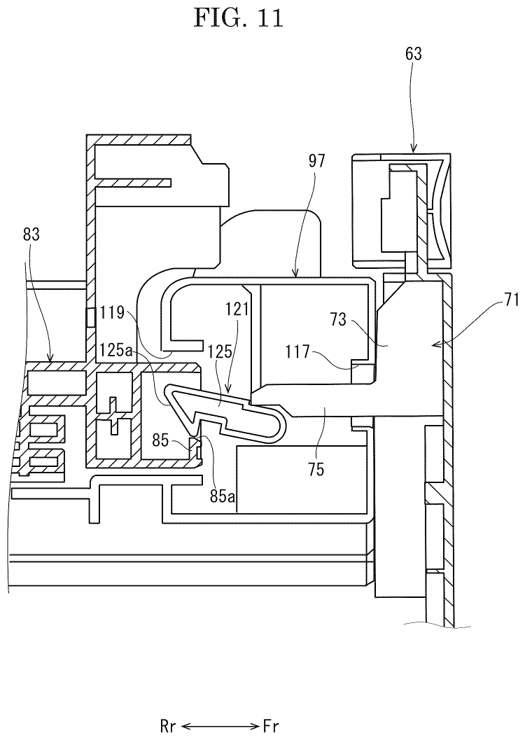

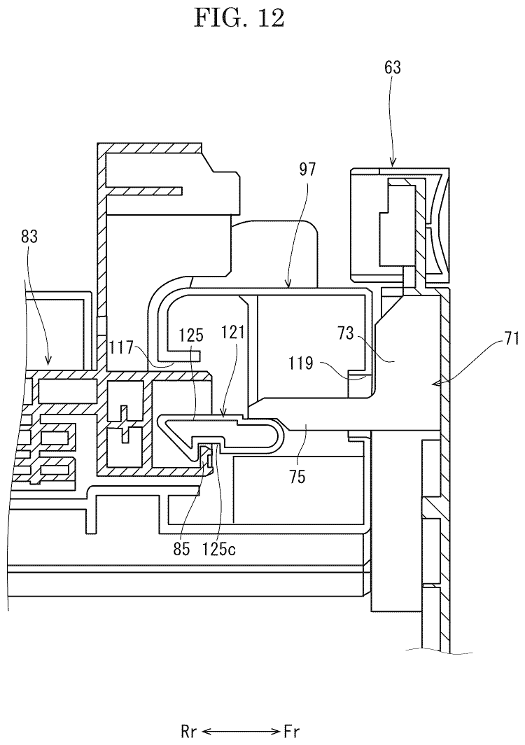

With reference to FIG. 10, FIG. 11, and FIG. 12, the operation of housing the pulled-out relay conveying unit 9 in the in-body sheet discharge space 7 in the image forming apparatus 1 having the above configuration will be described. FIG. 10, FIG. 11, and FIG. 12 are side views explaining a state in which the relay conveying unit 9 is housed in the in-body sheet discharge space 7 by the front cover 63. In this case, the front cover 63 is turned downward.

First, the relay conveying unit 9 is pushed to a certain extent into the in-body sheet discharge space 7. Then, as shown in FIG. 10, the conveying unit engaging parts 83 provided in the in-body sheet discharge space 7 enters the rear openings 119 of the front panel 97. Then, the left and right hooks 125 of the handle member 121 housed in the front panel 97 are inserted into the opening of the conveying unit engaging parts 83. Further, the tip end surface 125a of the hook 125 is guided by the upper surface 85a of the engaging piece 85 of the conveying unit engaging part 83, and the hook 125 is inclined upward.

Thereafter, when the front cover 63 is turned upward, the projecting portion 75 of the projection 71 provided in the front cover 63 is inserted into the front opening 117 of the front wall of the front panel 97.

When the front cover 63 is further turned, as shown in FIG. 11, the base portion 73 of the projection 71 of the front cover 63 abuts against the front wall of the front panel 97. Further, the lower corner of the projecting portion 75 of the projection 71 is in contact with the upper surface of the hook 125. When the front cover 63 is further turned in this state, the front panel 97 is pushed by the base portion 73 of the projection 71, and the relay conveying unit 9 is pushed into the in-body sheet discharge space 7.

As shown in FIG. 12, when the front cover 63 is turned to a vertical posture, the relay conveying unit 9 is pushed in to the normal position. Further, when the hook 125 of the handle member 121 exceeds the upper surface 85a of the engaging piece 85 of the conveying unit engaging part 83, the handle member 121 is biased by the springs 129 and returns to the initial posture. As described above, the spring 129 is an example of the biasing member which biases the hook 125 in a direction of engagement with the apparatus main body 31 (conveying unit engaging part 83).

As a result, the tip end of the engaging piece 85 enters the recess 125c of the hook 125, and the hook 125 is engaged with the engaging piece 85. When the front cover 63 is turned in the vertical posture, the upper surface 77a of the notch 77 of the projecting portion 75 of the projection 71 is on the horizontal plane. Accordingly, when the horizontal upper surface 77a is in contact with the upper surface of the hook 125, the hook 125 is turned into a posture extending along the horizontal direction, so that the hook 125 is securely engaged with the engaging piece 85. As a result, the relay conveying unit 9 is connected to the driving unit 11. That is, the couplings 105 of the conveying rollers 103 of the relay conveying unit 9 are coupled to the couplings 131 of the driving unit 11. As described above, the projection 71 provided on the front cover 63 is an example of the operation part which pushes the relay conveying unit 9 toward the in-body sheet discharge space 7 to connect the driving unit 11 and engages the hook 125 with the apparatus main body 31 (conveying unit engaging part 83) according to the present disclosure.

Thereafter, the motors 135 are driven to rotate the conveying rollers via the couplings 105 and 131, and the sheet is conveyed along the relay conveyance path 91. The sheet is conveyed to the post-processing apparatus through the discharge port 81.

When a sheet jam occurs in the relay conveyance path 91, the relay conveying unit 9 is pulled out from the in-body sheet discharge space 7. First, the front cover 63 is turned downward to open the front surface of the in-body sheet discharge space 7. Thereafter, as shown in FIG. 6 and FIG. 7, the handle 127 of the handle member 121 protruding from the upper opening 111 of the upper wall of the front panel 97 of the relay conveying unit 9 is turned toward the front fixing piece 113. For example, the thumb of the right hand is hooked to the front fixing piece 113, the other four fingers are hooked to the handle 127, and the handle 127 and the front fixing piece 113 are grasped by the four fingers and the thumb. As a result, the handle 127 moves forward, and the rotational shaft 123 is rotated. Then, the hook 125 is inclined upward and separated from the engaging piece 85, and the engagement between the relay conveying unit 9 and the conveying unit engaging part 83 is released.

Thereafter, the relay conveying unit 9 is pulled out forward while holding the handle 127 and the front fixing piece 113. Thereafter, the upper conveyance guide 93 is turned upward by holding the handle 101 of the upper conveyance guide 93. Thus, the relay conveyance path 91 is opened, and the jammed sheet can be removed. Thereafter, the relay conveying unit 9 is housed in the in-body sheet discharge space 7 by the above-described operation.

As described above, according to the present disclosure, by turning the front cover 63, the relay conveying unit 9 can be securely housed in the in-body sheet discharge space 7. That is, by turning the front cover 63 so as to close the front surface of the in-body sheet discharge space 7, the relay conveying unit 9 is pushed into the in-body sheet discharge space 7 by the front cover 63, and the hooks 125 provided in the relay conveying unit 9 can be securely engaged with the conveying unit engaging parts 83 provided on the in-body sheet discharge space 7 (apparatus main body 31). In particular, since the upper surface of the notch 77 of the projection 71 of the front cover 63 is brought into contact with the upper surface of the hook 125 by turning the front cover 63 in a normal posture, the hooks 125 can be reliably maintained in a posture in which they are engaged with the engaging piece 85. Therefore, the relay conveying unit 9 can be surely connected to the driving unit 11, and defective conveyance of the sheet can be suppressed.

When the handle 127 of the handle member 121 is held in order to pull out the relay conveying unit 9, the hooks 125 are automatically disengaged with the conveying unit engaging parts 83. Therefore, the pull-out operation of the relay conveying unit 9 can be simplified.

Further, since the springs 129 maintains the handle member 121 in the initial position in which the hook 125 extends rearward, the hooks 125 can be stably maintained in a state in which they are engaged with the engaging piece 85 of the conveying unit engaging part 83.

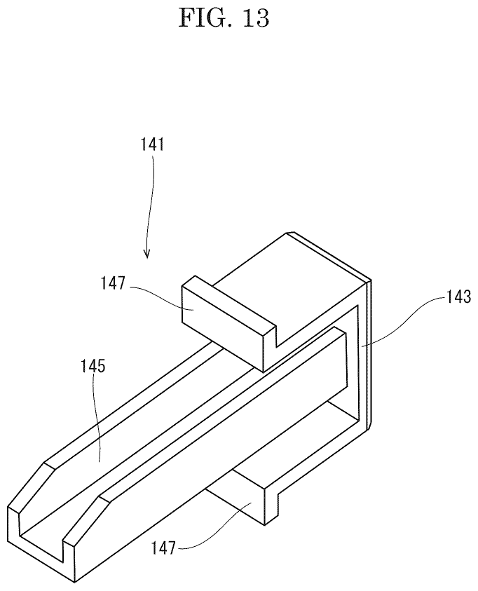

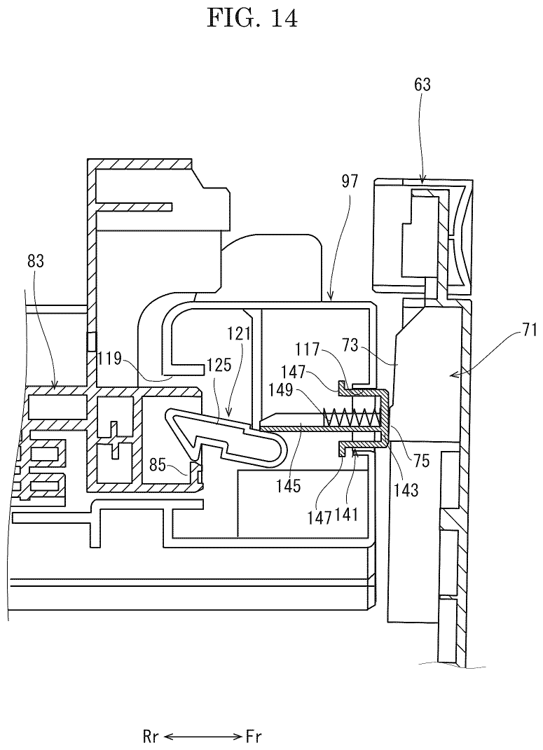

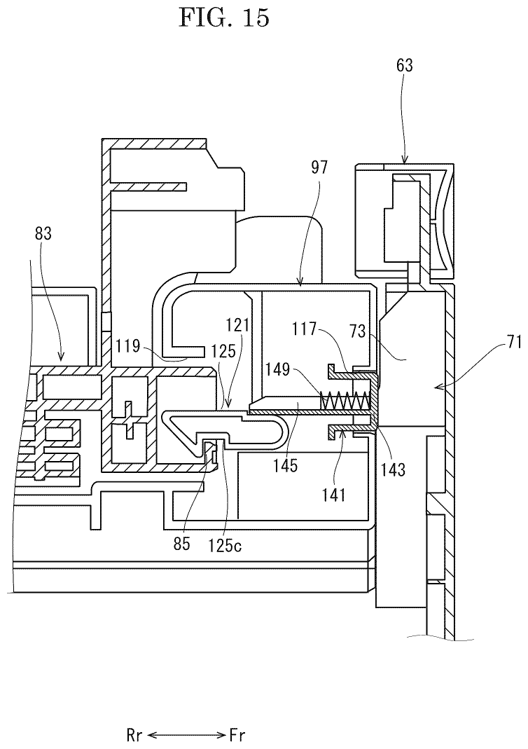

Next, another embodiment of the present disclosure will be described with reference to FIG. 13 to FIG. 15. FIG. 13 is a perspective view showing a pushing member 141, and FIG. 14 and FIG. 15 are side views explaining a state in which the relay conveying unit 9 is housed in the in-body sheet discharge space 7 by the front cover 63.

In another embodiment, a height of the projecting portion 75 of the projection 71 of the front cover 63 is lower than a height of the projecting portion 75 of the above embodiment. A height of the projecting portion 75 is equal to a height of the ribs of the front cover 63, and the tip surface of the projecting portion 75 is formed to be plane parallel to the inner and outer surfaces of the front cover 63.

A pushing member 141 is supported in the front opening 117 of the front panel 97 of the relay conveying unit 9 so as to be movable in the front-and-rear direction. As shown in FIG. 13, the pushing member 141 has a support portion 143 and a pressing portion 145. The support portion 143 is formed in a substantially U-shape having open side surfaces in a side view, and has a fixed wall and upper and lower walls. The upper and lower walls are formed with locking pieces 147 bent outward along the tip edges. The pressing portion 145 extends more forward from the inner surface of the fixed wall of the support portion 143 than the upper and lower walls. The pressing portion 145 has a substantially U-shaped cross section with an open top surface.

As shown in FIG. 14, the pushing member 141 is housed in the hollow space of the front panel 97, and the support portion 143 is inserted into the front opening 117 of the front panel 97. A coil spring 149 is housed in the pressing portion 145 of the pushing member 141. One end of the coil spring 149 abuts on the fixed wall of the support portion 143, and the other end abuts on a support piece (not shown) provided on the front panel 97. The coil spring 149 biases the pushing member 141 so that the support portion 143 of the pushing member 141 projects through the front opening 117. The pushing member 141 is biased until the locking piece 147 is locked to the peripheral edge of the front opening 117.

Next, the operation of housing the pulled-out relay conveying unit 9 in the in-body sheet discharge space 7. As shown in FIG. 14, when the relay conveying unit 9 is pushed into the in-body sheet discharge space 7 to some extent, the conveying unit engaging parts 83 provided in the in-body sheet discharge space 7 enter the rear openings 119 of the front panel 97. Then, the left and right hooks 125 of the handle member 121 housed in the front panel 97 are inserted into the openings of the conveying unit engaging parts 83. Further, the tip end surfaces 125a of the hooks 125 are guided by the upper surfaces 85a of the engaging pieces 85 of the conveying unit engaging parts 83, and the hooks 125 are inclined upward.

Thereafter, when the front cover 63 is turned upward, the distal end surface of the projecting portion 75 of the projection 71 provided in the front cover 63 comes into contact with the outer surface of the support portion 143 of the pushing member 141 supported by the front opening 117 of the front wall of the front panel 97.

Further, when the front cover 63 is turned, the pushing member 141 is pushed by the distal end surface of the projecting portion 75 of the projection 71 of the front cover 63, and the front panel 97 is pushed, and the relay conveying unit 9 is pushed into the in-body sheet discharge space 7.

As shown in FIG. 15, when the front cover 63 is turned to the vertical posture, the relay conveying unit 9 is pushed to the normal position. Further, the hooks 125 of the front cover 63 are engaged with the engaging pieces 85 of the conveying unit engaging parts 83. As a result, the relay conveying unit 9 is connected to the driving unit 11. In this embodiment, the projection 71 of the front cover 63 and the pushing member 141 are an example of the operation part which pushes the relay conveying unit 9 toward the in-body sheet discharge space 7 to connect the driving unit 11 and engages the hooks 125 with the apparatus main body 31 (conveying unit engaging parts 83).

In the above-described embodiment, only the projection 71 provided on the front cover 63 pushes the relay conveying unit 9, and maintains the hooks 125 in a posture of engaging with the engaging pieces 85, so that the configuration of the front cover 63 and the front panel 97 can be relatively simplified. On the other hand, in another embodiment, since the projection 71 does not protrude from the front cover 63, when the front cover 63 is turned downward, it does not obstruct the sheet jam treatment operation.

When the front cover 63 is closed, the tip of the projecting portion 75 of the projection 71 (the pressing portion 145 of the pushing member 141) may push the stepped surface 125b of the hook 125.

Further, since the above-described description of the embodiments of the present disclosure describes the preferred embodiments of the present disclosure, various technically preferable limitations may be added, but the technical scope of the present disclosure is not limited to these embodiments unless specifically limiting the present disclosure is stated.

1. An image forming apparatus comprising:
a relay conveying unit which includes a conveying member for conveying a sheet on which an image is formed, and is housed in a storage space of an apparatus main body so as to be pulled out;
a driving unit which is provided in the apparatus main body, and is coupled to the relay conveying unit housed in the storage space to apply a driving force to the relay conveying unit; and
a cover which is turnable, and opens and closes the storage space, wherein
the relay conveying unit includes a hook which is engaged with the apparatus main body when the relay conveying unit is coupled to the driving unit, and
the cover includes an operation part which pushes the relay conveying unit toward the storage space to connect the relay conveying unit to the driving unit and to engage the hook with the apparatus main body by turning in a direction of closing the storage space.

2. The image forming apparatus according to claim 1, wherein
the relay conveying unit include a handle provided integrally with the hook, the handle being held when the relay conveying unit is pulled out from the storage space, and
when the handle is held, the hook is turned to be disengaged with the apparatus main body.

3. The image forming apparatus according to claim 1, wherein
the cover includes a biasing member which biases the hook in a direction engaging with the apparatus main body.

4. The image forming apparatus according to claim 1, wherein
the operation part is a projection provided in the cover.

5. The image forming apparatus according to claim 1, wherein
the operation part includes:
a projection provided in the cover, and
a pushing member which is movably supported by the relay conveying unit and turns the hook by being pushed by the projection.

6. The image forming apparatus according to claim 1, wherein
the relay conveying unit include an upper conveyance guide and a lower conveyance guide which form a relay conveyance path along which the sheet is conveyed, and
a rear end of the upper conveyance guide is turnably connected to a rear end of the lower conveyance guide.
